(19) United States
(12) Patent Application Publication
(10) Pub. No.: US 2010/0142093 A1
(43) Pub. Date: Jun. 10, 2010

(54) STORAGE DEVICE AND METHOD OF CALCULATING TRANSFER AMOUNT OF LUBRICANT

(75) Inventors: Hiroyuki KUBOTERA, Yamato-shi (JP); Takahiro IMAMURA, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/631,669

(22) Filed: Dec. 4, 2009

(30) Foreign Application Priority Data
Dec. 5, 2008 (JP) 2008-310516

(51) Int. Cl. G11B 5/60

(52) U.S. Cl. 360/235.4; G9B/5.229

(57) ABSTRACT

According to one embodiment, a storage device includes a storage medium and a head slider. The storage medium includes a surface coated with a lubricant. The head slider includes a medium facing surface that faces a surface of the storage medium based on the relative movement to the storage medium. The product ph [atm·nm] of air pressure p [atm] defined between the surface of the storage medium and the medium facing surface and a floating amount h [nm] of the medium facing surface defined from the surface of the storage medium satisfies

ph≧0.0129 Mn+71.344

with respect to the molecular weight Mn of the lubricant.

### CROSS-REFERENCE TO RELATED APPLICATIONS

This application is based upon and claims the benefit of priority from Japanese Patent Application No. 2008-310516, filed Dec. 5, 2008, the entire contents of which are incorporated herein by reference.

### BACKGROUND

1. Field

One embodiment of the invention relates to a storage device with a head slider that floats over a storage medium having a surface coated with a lubricant.

2. Description of the Related Art

In a hard disc drive (HDD), a head slider floats over a magnetic disc when magnetic information is written thereto or read therefrom. At this time, a lubricant is, for example, evaporated and transferred to the medium facing surface of the head slider. If the transferred lubricant is agglomerated on the medium facing surface, a lubricant lump drops onto a surface of the magnetic disc. The lump comes contact with the head slider, and thereby head crash occurs.

Reference may be had to Japanese Patent Application Publication (KOKAI) No. H8-279120, Japanese Patent Application Publication (KOKAI) No. 2003-109340, Japanese Patent Application Publication (KOKAI) No. 2000-348303, Japanese Patent Application Publication (KOKAI) No. 2006-196137, Japanese Patent Application Publication (KOKAI) No. H7-21717, and Japanese Patent Application Publication (KOKAI) No. 2002-175676.

Reference may also be had to Bruno Marchon, Tom Karis, Qing Dai and Remmelt Pit, “A Model for Lubricant Flow From Disk to Slider”, IEEE Transactions on Magnetics, Vol. 39, No. 5, September 2003, pp. 2447-2449, Yansheng Ma and Bo Liu, “Lubricant transfer from disk to slider in hard disk drives”, Applied Physics Letters, 90, 143516, 2007, and Bo Zhang and Akira Nakajima, “Hydrodynamic Lubrication of Slider Air Bearings with the Pumping Effect”, in Proc. Micromechatronics for Information and Precision Equipment, Santa Clara, Calif., June 2006.

As described above, it is well known that the lubricant moves between the magnetic disc and the head slider. However, a method of inhibiting the lubricant from being transferred from the magnetic disc to the head slider has not been disclosed.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plane view of an internal structure of a hard disc drive (HDD) as an example of a storage device according to a first embodiment of the invention;

FIG. 2 is an exemplary enlarged perspective view of a flying head slider in the first embodiment;

FIG. 3 is an exemplary enlarged plane view of the flying head slider in the first embodiment;

FIG. 4 is an exemplary cross-sectional view of the floating posture of the flying head slider when a protrusion is not formed in the first embodiment;

FIG. 5 is an exemplary cross-sectional view of the floating posture of the flying head slider when a protrusion is formed in the first embodiment;

FIG. 6 is an exemplary cross-sectional view of movement of lubricant molecules and air molecules between the medium facing surface of the flying head slider and a surface of a magnetic disc in the first embodiment;

FIG. 7 is an exemplary graph of a relationship between a reaching rate and the product of air pressure and a floating amount in the first embodiment;

FIG. 8 is an exemplary graph of a relationship between a constant term and a molecular weight of lubricant molecules in the first embodiment;

FIG. 9 is an exemplary graph of a relationship between a floating amount and air pressure;

FIG. 10 is an exemplary enlarged perspective view of a flying head slider according to a second embodiment of the invention; and

FIG. 11 is an exemplary enlarged plane view of the flying head slider.

### DETAILED DESCRIPTION

Various embodiments according to the invention will be described hereinafter with reference to the accompanying drawings. In general, according to one embodiment of the invention, a storage device comprises a storage medium and a head slider. The storage medium is configured to include a surface coated with a lubricant. The head slider is configured to include a medium facing surface that faces a surface of the storage medium based on the relative movement to the storage medium. The product ph [atm·nm] of air pressure p [atm] defined between the surface of the storage medium and the medium facing surface and a floating amount h [nm] of the medium facing surface defined from the surface of the storage medium satisfies

ph≧0.0129 Mn+71.344

with respect to the molecular weight Mn of the lubricant.

According to another embodiment of the invention, there is provided a method of calculating a transfer amount of a lubricant, comprising calculating a transfer amount of a lubricant on a storage medium to a medium facing surface of a head slider based on the product ph [atm·nm] of air pressure p [atm] defined between a surface of the storage medium and the medium facing surface and a floating amount h [nm] of the medium facing surface defined from the surface of the storage medium.

According to still another embodiment of the invention, a head slider comprises a slider body, a rear rail, a step surface, and an air bearing surface. The slider body is configured to define a medium facing surface. The rear rail is formed at an air outflow end side of the medium facing surface. The width of the rear rail defined in the width direction of the slider body is configured to decrease toward the air outflow end from the air inflow end. The step surface is configured to be defined at the air inflow end side of the rear rail on the rear rail. The air bearing surface is configured to be defined at the air outflow end side of the rear rail on the rear rail and be connected to the step surface through a step difference. At least one of crossing angles between an extension line of the contour of the rear rail defined at a side of the rear rail and the front-rear direction center line of the slider body is larger than the maximum skew angle.

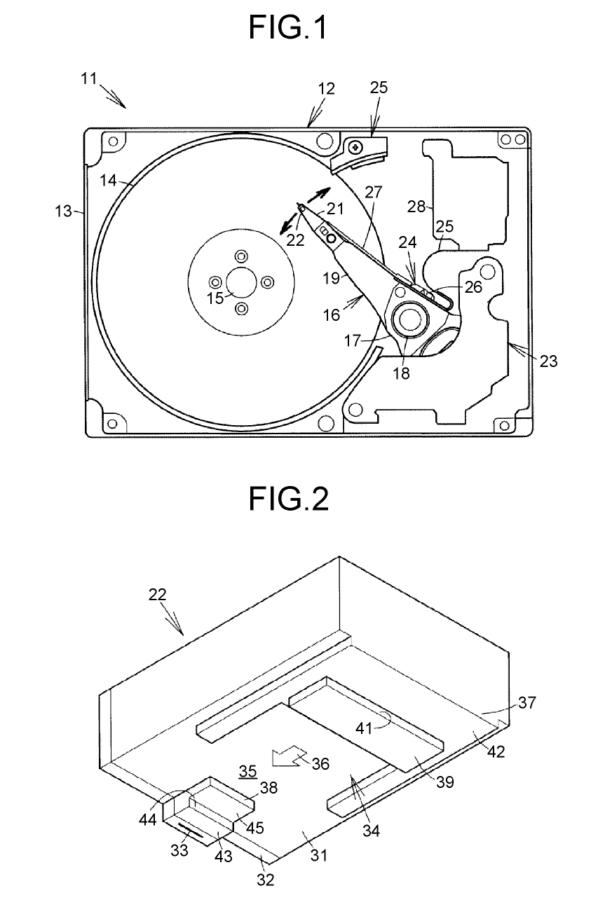

FIG. 1 schematically illustrates an internal structure of a hard disc drive (HDD) 11 as an example of a storage device according to a first embodiment of the invention. The HDD 11 comprises a housing 12. The housing 12 comprises a box-shaped base 13 and a cover (not illustrated). The base 13 defines, for example, a flat rectangular parallelepiped internal space, i.e., a housing space. The base 13 may be formed by casting with a metal material such as aluminum (Al). The cover is coupled to an opening of the base 13. The housing space is sealed between the cover and the base 13. The cover may be formed by, for example, pressing a piece of plate.

In the housing space, one or more magnetic disks 14 are housed as storage media. The magnetic disc 14 is mounted on the rotation axis of a spindle motor 15. The spindle motor 15 can rotate the magnetic disk 14 at high speed, such as 5400 rpm, 7200 rpm, 10000 rpm, and 15000 rpm. For example, the magnetic disc 14 is configured as a vertical magnetic recording disc. That is, in a recording magnetic film on the magnetic disc 14, a magnetization easy axis is set in the vertical direction perpendicular to a surface of the magnetic disc 14.

In the housing space, a carriage 16 is further housed. The carriage 16 comprises a carriage block 17. The carriage block 17 is rotatably connected to a support shaft 18 extending in the vertical direction. In the carriage block 17, a plurality of carriage arms 19, which extend a horizontal direction from the support shaft 18, are defined. The carriage block 17 may be formed by, for example, extruding aluminum (Al).

Attached to a front end of each of the carriage arms 19 is a head suspension 21. The head suspension 21 extends forward from the front end of the carriage arm 19. A flexure is attached to a front end of the head suspension 21. A gimbal spring is defined in the flexure. Due to the action of the gimbal spring, a flying head slider 22 may change its posture with respect to the head suspension 21. As will be described later, a head device, i.e., an electromagnetic transducer device, is mounted on the flying head slider 22.

When an air flow is produced on a surface of the magnetic disk 14 by rotation of the magnetic disk 14, positive pressure, i.e., buoyancy, and negative pressure act on the flying head slider 22 by the action of the air flow. When the buoyancy, the negative pressure, and a pressing force of the head suspension 21 are in balance, the flying head slider 22 can keep floating with relatively high rigidity during the rotation of the magnetic disc 14.

When the carriage 16 rotates around the support shaft 18 while the flying head slider 22 is floating, the flying head slider 22 can move along a radial line of the magnetic disc 14. As a result, the electromagnetic transducer device on the flying head slider 22 can traverse a data zone between the innermost recording track and the outermost recording track. Thus, the electromagnetic transducer device on the flying head slider 22 is positioned on a target recording track.

A power source such as a voice coil motor (VCM) 23 is connected to the carriage block 17. By the action of the VCM 23, the carriage block 17 can rotate around the support shaft 18. Such rotation of the carriage block 17 enables reciprocation of the carriage arm 19 and the head suspension 21.

As can be seen from FIG. 1, a flexible printed board unit 24 is arranged on the carriage block 17. The flexible printed board unit 24 comprises a head integrated circuit (IC) 26 mounted on a flexible printed board 25. The head IC 26 is connected to a reading element and a writing element of the electromagnetic transducer device by using a flexure 27. The flexure 27 is connected to the flexible printed board unit 24. The flexure 27 is provided with a wiring pattern. The wiring pattern mutually connects the flying head slider 22 and the flexible printed board 25.

To read out magnetic information, a sense current is supplied from the head IC 26 to the reading element of the electromagnetic transducer device. For example, a reading element of a CPP structure is used as the reading element. Similarly, in order to write magnetic information, an electric current is supplied from the head IC 26 to the writing element of the electromagnetic transducer device. For example, a single magnetic pole head element is used as the writing element. A current value of the sense current is set to a certain value. An electric current is supplied to the head IC 26 from a small-sized circuit substrate 28 arranged in the accommodation space or a printed circuit board (PCB) (not illustrated) attached to an under side of a bottom plate of the base 13.

FIG. 2 illustrates the flying head slider 22 of the first embodiment. The flying head slider 22 comprises a slider body 31 formed in, for example, flat rectangular parallelepiped shape. A non-magnetic film, i.e., an device built-in film 32, is stacked on an air outflow side end face of the slider body 31. An electromagnetic transducer device 33 is built in the device built-in film 32. The slider body 31 may be made of a hard non-magnetic material such as, for example, Al₂O₃—TiC (AlTic). The device built-in film 32 may be made of a relatively soft insulating non-magnetic material such as Al₂O₃ (alumina).

The flying head slider 22 faces the magnetic disc 14 with the medium facing surface, i.e., a floating surface 34. A flat base surface 35, i.e., a reference surface, is defined on the floating surface 34. When the magnetic disc 14 rotates, an air flow 36 works on the floating surface 34 from the front end toward the rear end of the slider body 31.

A piece of front rail 37 which rises from the base surface 35 is formed on the floating surface 34 at the upstream of the air flow 36, i.e., at the air inflow side. The front rail 37 extends in the slider width direction along the air inflow end of the base surface 35. Similarly, a rear center rail 38 which rises from the base surface 35 is formed on the floating surface 34 at the downstream of the air flow 36, i.e., at the air outflow side. The rear center rail 38 is arranged at the center in the slider width direction. The rear center rail 38 extends from the slider body 31 to the device built-in film 32.

An air bearing surface (ABS) 39 is defined on the top surface of the front rail 37. The air inflow end of the air bearing surface 39 comes into contact with a step surface 42 of the front rail 37 through a step difference 41. The step surface 42 is at a level one step lower than the air bearing surface 39. The step surface 42 is defined at the air inflow end side of the front rail 37. The air bearing surface 39 is defined at the air outflow end side of the front rail 37.

Similarly, an ABS 43 is defined on the top surface of the rear center rail 38. The air inflow end of the air bearing surface 43 comes into contact with a step surface 45 of the rear center rail 38 through a step difference 44. The step surface 45 is at a level one step lower than the air bearing surface 43. The step surface 45 is defined at the air inflow end side of the rear center rail 38. The air bearing surface 43 is defined at the air outflow end side of the rear center rail 38.

The air flow 36 generated by the rotation of the magnetic disc 14 is received by the floating surface 34. At this time, because of the presence of the step differences 41 and 44, a relatively high positive pressure, i.e., buoyancy, is generated on the air bearing surfaces 39 and 43. Further, high negative pressure is generated behind, i.e., at the rear of the front rail 37. The floating posture of the flying head slider 22 is determined by balance of the buoyancy and the negative pressure.

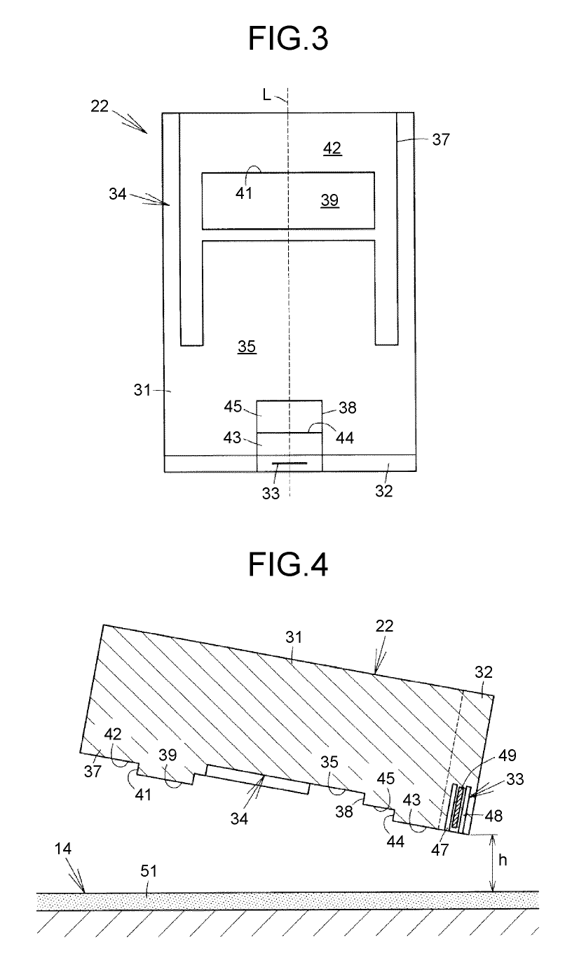

Referring to FIG. 3 together, the rear center rail 38 is arranged on a front-rear direction center line L which connects the center of the air inflow end of the floating surface 34 to the center of the air outflow end of the floating surface 34. The width of the rear center rail 38 defined in the slider width direction is equally defined from the air inflow end to the air outflow end along the front-rear direction center line L. That is, the contour of the rear center rail 38 defined at the side of the rear center rail 38 extends in parallel with the front-rear direction center line L.

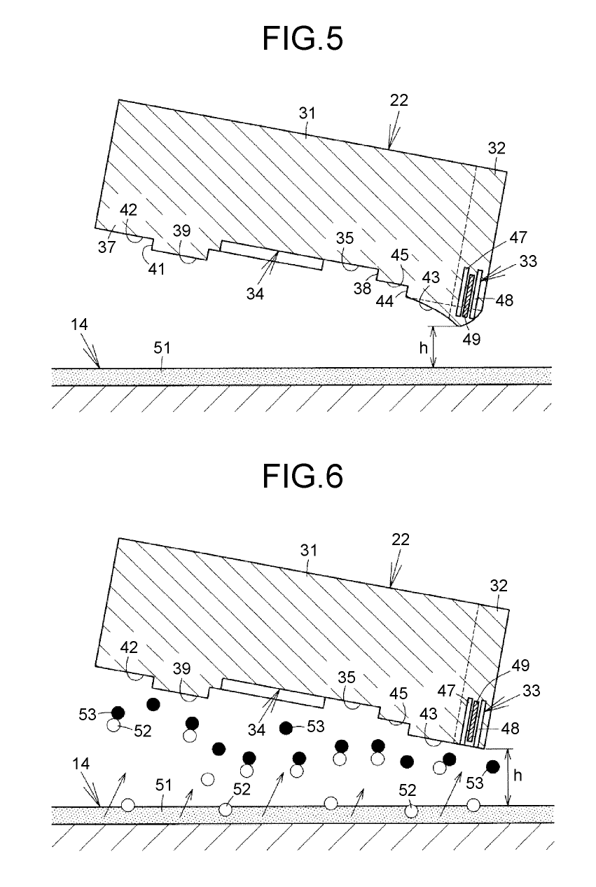

As illustrated in FIG. 4, the electromagnetic transducer device 33 comprises a reading element 47 and a writing element 48. A heater 49 is arranged between the reading element 47 and the writing element 48. The heater 49 is formed of, for example, an electrical heating wire made of tungsten (W) or titan-tungsten (TiW). When electrical power is supplied to the heater 49, the heater 49 generates heat. Due to the heat of the heater 49, the reading element 47 or the writing element 48 and the device built-in film 32 are thermally expanded together with the heater 49. As a result, as illustrated in FIG. 5, the device built-in film 32 and the slider body 31 rise from the top surface of the rear center rail 38, and a protrusion is formed. The electromagnetic transducer device 33 is displaced toward the magnetic disc 14. A floating amount h of the electromagnetic transducer device 33 is determined depending on a protrusion amount of the protrusion.

The magnetic disc 14 has a surface coated with a lubrication film 51. The thickness of the lubrication film 51 is set to, for example, about 1 nm. The lubrication film 51 is made of, for example, a lubricant such as perfluoropolyether (PFPE). As illustrated in FIG. 6, due to the evaporation of the lubricant, lubricant molecules 52 are present between the floating surface 34 of the flying head slider 22 and a surface of the magnetic disc 14. Meanwhile, numerous air molecules 53 are present between the floating surface 34 and the surface of the magnetic disc 14. The air molecules 53 contain a nitrogen (N₂) molecule and an oxygen (O₂) molecule. The lubricant molecules 52 collide with the air molecules 53 in the process of reaching the floating surface 34, and are flicked. As a result, the air molecules 53 forbid the lubricant molecules 52 from being transferred to the floating surface 34.

The inventor analyzed the movement of the lubricant molecules 52 and the air molecules 53 between the floating surface 34 and the surface of the magnetic disc 14. The direct simulation Monte Carlo (DSMC) technique was used for the analysis. For implementation of the analysis, first to third models were set. In the first to third models, molecular weights Mn of the lubricant molecules 52 were set to 2510, 4500, and 6500, respectively. In all the models, the lubricant molecule 52 was assumed as a hard sphere. A ratio of a nitrogen (N₂) molecule to an oxygen (O₂) molecule of the air molecule 53 was set to, for example, 80[%]:20[%].

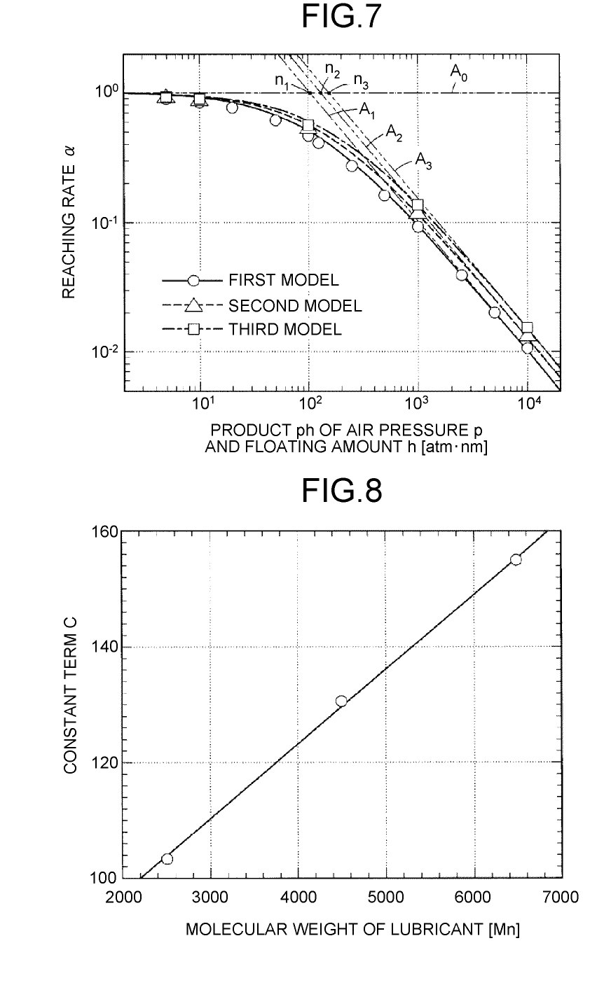

As a result of analysis through the DSMC technique, as illustrated in FIG. 7, it was found that a reaching rate a in which the lubricant molecules 52 reached the floating surface 34 was defined by a product ph [atm·nm] of air pressure p [atm] and a floating amount h [nm] defined between the floating surface 34 and the surface of the magnetic disc 14. The reaching rate α is expressed by a ratio of an amount of the lubricant molecules 52 transferred to the floating surface 34 to a total of the lubricant molecules 52 evaporated from the magnetic disc 14, and 10°, i.e., 1, corresponds to 100%. In all the models, as the product ph increased, the reaching rate a decreased. Thus, it was found that the reaching rate a of the lubricant molecules 52 to the floating surface 34 was able to be adjusted by adjusting the air pressure p or the floating amount h between the floating surface 34 and the surface of the magnetic disc 14.

As the air pressure p increases, the number of the air molecules 53 between the floating surface 34 and the surface of the magnetic disc 14 increases. Therefore, it is considered that as the air pressure p increases, the lubricant molecules 52 are likely to collide with the air molecules 53. As a result, the reaching rate a of the lubricant molecules 52 to the floating surface 34 decreases. Thus, transfer of the lubricant molecules 52 to the floating surface 34 is inhibited. On the other hand, as the floating amount h increases, the number of the air molecules 53 between the floating surface 34 and the surface of the magnetic disc 14 increases. Therefore, it is considered that as the floating amount h increases, the lubricant molecules 52 are likely to collide with the air molecules 53. The reaching rate a of the lubricant molecules 52 to the floating surface 34 decreases. As a result, transfer of the lubricant molecules 52 to the floating surface 34 is inhibited.

The inventor formulated the reaching rate a based on the analysis result through the DSMC technique. The reaching rate α is expressed by Equation (1) as follows:

$$α = \frac{C}{( p h + C )} \qquad ( 1 )$$

where C is a constant term. It can be understood from Equation (1) that the reaching rate α is in inverse proportion to a sum of the product ph and a predetermined constant term C. As the product ph is set to be smaller than the constant term C, the reaching rate α gradually approaches 1. It can be understood from Equation (1) that when the product ph is larger than the constant term C, the reaching rate α is in inverse proportion to the product ph. That is, as the product ph, i.e., the air pressure p or the floating amount h, increases, the reaching rate a decreases. Therefore, it becomes clear that it is important in reducing the reaching rate α to set the product ph to be equal to or more than the constant term C.

As can be seen from FIG. 7, a slope of a curve remarkably changes from a point in which the product ph is a value of about 10², i.e., 100 [atm·nm]. When the reaching rate α is the maximum value, i.e., 10⁰, an asymptotic line A₀ is set in the first to third models. Similarly, when the reaching rate α is the minimum value, asymptotic lines A₁ to A₃ are set in the first to third models, respectively. At this time, intersection points n₁ to n₃ are established between the asymptotic line Aₒ and asymptotic lines A₁ to A₃. Since the slope of the reaching rate α changes at the intersection points n₁ to n₃, it can be understood that values of the intersection points n₁ to n₃ correspond to the constant term C. Here, the constant term C changes depending on the molecular weight Mn. A value of the constant term C at the intersection point n₁ represents 103.2. A value of the constant term C at the intersection point n₂ represents 130.5. A value of the constant term C at the intersection point n₃ represents 154.7.

A relationship between the molecular weight Mn and the constant term C was calculated. As a result, as illustrated in FIG. 8, it was found that as the molecular weight Mn increased, the constant term C increased. A relationship between the molecular weight Mn and the constant term C is expressed by a linear function. Based on the relationship, the constant term C is expressed by Equation 2 as follows:

C=0.0129 Mn+71.344 (2)

As described above, since it is necessary to set the product ph to be equal to or more than the constant term C, the following Equation (3) is derived:

ph≧0.0129 Mn+71.344 (3)

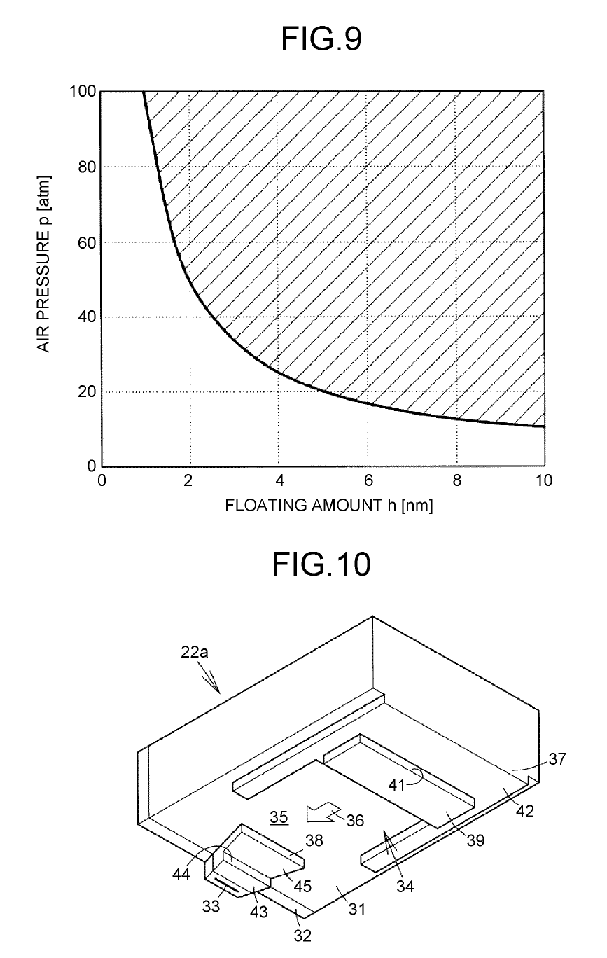

A relationship between the floating amount h and the air pressure p illustrated in FIG. 9 is derived from Equation (3).

In FIG. 9, it is assumed that the lubricant molecule 52 has a molecular weight of, for example, 2510. At this time, the floating amount h and the air pressure p are set to a range of a hatched area. The floating amount h and the air pressure p are set to, for example, within the range on the air bearing surfaces 39 and 43. The floating amount h and the air pressure p may be set to within the range over the entire surface of the floating surface 34. In the first embodiment, for example, the floating amount h is set by adjusting the protrusion amount of the protrusion. Besides, for example, the air pressure p is set based on the shape of the air bearing surface 43.

As described above, in the HDD 11, the product ph of the floating amount h and the air pressure p between the floating surface 34 and the surface of the magnetic disc 14 is set to a value equal to or more than a predetermined value. As a result, transfer of the lubricant molecules 52 to the floating surface 34 is inhibited. Therefore, the flying head slider 22 can stably float for a long time. Further, a new component does not need to be added to the flying head slider 22 to prevent the lubricant molecules 52 from being transferred to the floating surface 34. Thus, extra cost is not required. The presence of the air molecules 53 is considered in calculating the product ph. Therefore, a transfer amount of the lubricant molecules 52 transferred to the floating surface 34 is calculated with higher accuracy compared to conventional technologies.

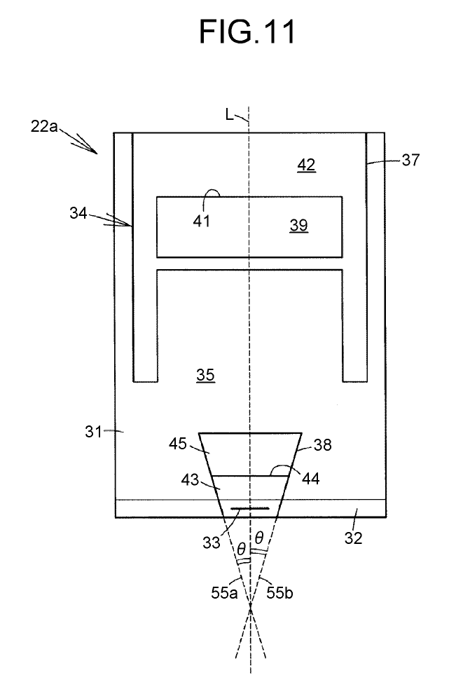

FIG. 10 schematically illustrates a structure of a flying head slider 22a according to a second embodiment of the invention. In the flying head slider 22a, as the rear center rail 38 heads for the air outflow end from the air inflow end along the direction center line L, a width defined in the slider width direction is reduced. Referring to FIG. 11 together, the contour of the rear center rail 38 is defined on the side of the rear center rail 38. Extension lines 55a and 55b of the contour which extend from the rear center rail 38 to the air outflow end side cross the front-rear direction center line L at a predetermined crossing angle θ. The crossing angle θ is set to be larger than the maximum skew angle. The contours 55a and 55b may have the same crossing angle θ as each other or different crossing angles θ from each other. The skew angle is represented by a crossing angle between the front-rear center line L and the down track direction of the magnetic disc 14. Incidentally, constituent elements or structures corresponding to those of the flying head slider 22 are designated by the same reference numeral.

According to the flying head slider 22a, if the flying head slider 22a is arranged at any radial direction position on the magnetic disc 14, the air flow 36 flowing in toward the rear center rail 38 works on the step surface 45 and the air bearing surface 43. That is, the air flow 36 works on the air bearing surface 43 through both a step difference between the base surface 35 and the step surface 45 and a step difference between the step surface 45 and the air bearing surface 43. As a result, sufficiently high positive pressure, i.e., buoyancy, is generated in the air bearing surface 43 at any radial direction position on the magnetic disc 14. Therefore, high air pressure p is generated between the floating surface 34 or the air bearing surface 43 and the surface of the magnetic disc 14. Thus, transfer of the lubricant molecules 52 to the floating surface 34 is inhibited.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device comprising:
a storage medium comprising a surface coated with a lubricant; and
a head slider comprising a surface facing a surface of the storage medium based on relative movement to the storage medium, wherein
a product ph [atm·nm] of air pressure p [atm] between the surface of the storage medium and the surface of the head slider and a floating amount h [nm] of the surface of the head slider from the surface of the storage medium satisfies:
ph≧0.0129 Mn+71.344
where Mn is a molecular weight of the lubricant.

2. The storage device of claim 1, wherein the product ph satisfies the equation all over the surface of the head slider.

3. A method of calculating a transfer amount of a lubricant, comprising calculating a transfer amount of a lubricant on a storage medium to a surface of a head slider based on a product ph [atm·nm] of air pressure p [atm] between a surface of the storage medium and the surface of the head slider and a floating amount h [nm] of the surface of the head slider from the surface of the storage medium.

4. The method of claim 3, wherein a ratio α of the transfer amount to a total of an evaporation amount of the lubricant satisfies:
$$α = \frac{C}{( p h + C )}$$
where C is a constant term.

5. The method of claim 4, wherein the constant term C is calculated by
C=0.0129 Mn+71.344
wherein Mn is a molecular weight of the lubricant.

6. A head slider comprising:
a slider body comprising a surface;
a rear rail at an air outflow end side of the surface, comprising a width of the rear rail in a width direction of the slider body configured to decrease toward an air outflow end from an air inflow end;
a step surface at an air inflow end side of the rear rail; and
an air bearing surface at an air outflow end side of the rear rail on configured to be connected to the step surface through a step difference, wherein
at least one of crossing angles between an extension line of a contour of the rear rail at a side of the rear rail and a front-rear direction center line of the slider body is larger than a maximum skew angle.
